(19) United States
(12) Patent Application Publication
(10) Pub. No.: US 2003/0135848 A1
(43) Pub. Date: Jul. 17, 2003

(54) Use of multiple procedure entry and/or exit points to improve instruction scheduling

(75) Inventor: Sivaram Krishnan, Los Altos, CA (US)

Correspondence Address: David T. Cunningham, Esq., Hitachi America, Ltd., 50 Prospect Avenue, Tarrytown, NY, 10591, US

(73) Assignee: Hitachi, Ltd., Tokyo (JP)

(21) Appl. No.: 10/029,496

(22) Filed: Dec. 21, 2001

(51) Int. Cl. G06F 9/45

(52) U.S. Cl. 717/158

(57) ABSTRACT

In a repeated sequence of instructions of a procedure based language, multiple entry points and/or exit points, that is access points, control repetitions and create multiple code segments. At least one segment is executed fewer times than the number of repetitions n that the entire sequence of instructions is called. At least one of the repetitions has extra code that is not necessary in all or some of the repetitions, and the extra code is isolated by the added access points, to improve speed of execution through reduction of machine cycles. In contrast to the external call entry and exit points, for example, the added entry and/or exit point is used only within the function itself during repetitions. When executed, the internal calls of added entry and/or exit points cause one segment to have fewer repetitions than another segment. A specific example is that of a recursive sequence of instructions.

### BACKGROUND OF THE INVENTION

The present invention relates to improving the speed and efficiency of the execution of a sequence of instructions.

Code is a sequence of program, i.e. machine readable, instructions to a processor.

Recursive execution involves a routine or module or subroutine or simply a series of instructions, all herein referred to more broadly as a sequence of instructions, that has one or more instructions controlling the repeated execution of the sequence. The sequence thereby performs a function, which may be used to implement search strategies or perform repetitive calculations, for example. Recursion, for example, can implement some algorithms with a small, simple sequence of instructions; but the execution is not necessarily fast or efficient. Some recursive sequences of instructions can cause a program to run out of stack space, become very long and inefficient in execution and even cause the entire system to crash. A call is one or more instructions that transfer execution to a specific sequence of instructions of the program; the call may be an external call originating outside of the sequence or an internal or recursive call wherein the sequence calls itself for recursion. In recursion, each passage through the recursive portion of the sequence, which may be the entire sequence, is an invocation. An invocation is thus a procedure.

Loop execution, involves the execution of a sequence of instructions repeatably a fixed number of times or until a condition is fulfilled. Each repetition is an iteration. Loop performance has been improved in some instances by moving one or more instructions outside of the loop or across different loop iterations as in U.S. Pat. No. 5,386,562. U.S. Pat. No. 6,088,525 discloses the use of instrumentation code and multiple entry/exit points for loops, which is not at the procedural or functional level as in recursive calls. U.S. Pat. No. 6,253,373 relates to the operation of a compiler, particularly with respect to identifying a loop beginning and end.

One measure of performance of both a computer system and a software program is speed of execution by a processor. Increased program execution speed is always highly desirable and continually sought by programmers and users alike.

These and other needs are addressed by the present invention.

In a software program, a call transfers program execution to some segment of code, for example the segment may be a subroutine in or outside the program doing the calling. The segment of code called performs some specific task (function) with its sequence of instructions (code sequence). Once the task has been performed, the execution in the processor usually returns to the calling point of the calling program.

In a software program, an entry point is a position in the instruction sequence where execution can begin. The beginning of the sequence is usually an entry point, as is the calling point when the execution returns from a called subroutine, for example. The programmer who writes a program determines entry points. The FORTRAN language supports multiple entry points through a user directive, but for a purpose unrelated to the present invention.

In a software program, an exit point is a position in the instruction sequence where execution ends, temporarily when the execution transfers or permanently at the end of the program, for example. The programmer who writes a program determines exit points. Many procedural languages allow multiple exit points, but for a purpose unrelated to the present invention.

### SUMMARY OF THE INVENTION

The present inventor has analyzed the above mentioned needs as problems to be solved, identified and analyzed causes of the problems, and provided solutions to the problems. This analysis of the problems, the identification and analysis of the causes, and the provision of solutions are each parts of the present invention and are set forth below.

In analyzing the above-mentioned program execution speed problems, the inventor has found that a part of the problem is that a repeated sequence of instructions for a function in software program frequently involves execution of unnecessary instructions in the sequence of instructions.

A cause of this unnecessary execution, for example in recursive functions, is that some of the function instructions are needed only in specific invocations of the functions, but not in other invocations of the functions. In the other invocations of the functions, these now unnecessary instructions are executed, wasting machine cycles.

Another cause of this unnecessary execution is that some of the instructions needed in one or some passes through a repeated sequence of instructions are not needed in other passes. For example, in some passes of a sequence of instructions, one or some instructions of the initial passe are not needed and their execution in the some others of the passes would waste machine cycles.

As a result of both the above problem causes, the execution of unnecessary instructions takes a large number of processor machine cycles and thereby incurs a considerable performance penalty by slowing up the execution of the program and the slowing of the running of the computer system, both of which are undesirable. The above examples are representative of a more general case involving execution of instruction segments.

This invention solves the problems of some of the performance (speed of execution) penalty by eliminating the causes and more particularly by defining multiple procedure entry points and/or exit points and multiple code segments of a sequence of instructions. By proper choosing of different such entry and/or exit points to define multiple code segments, the execution of unnecessary instructions is avoided, resulting in better performance of the system and program.

### BRIEF DESCRIPTION OF THE DRAWINGS

The present invention is illustrated by way of a preferred embodiment, best mode and example related to recursive code, and is not defined by way of limitation. Further objects, features and advantages of the present embodiment will become more clear from the following detailed description of a preferred embodiment and best mode of implementing the invention, as shown in the figures of the accompanying drawing, in which like reference numerals refer to similar elements, wherein:

FIG. 1 illustrates a computer system that implements an embodiment of the present invention;

FIG. 2 is a flowchart showing a method of operating the system and guidelines to write a program for a recursive instruction sequence modification, as embodiments; and

FIG. 3 is a flowchart showing a method of operating the system and guidelines to write a program for a recursive instruction sequence modification, as embodiments.

### DETAILED DESCRIPTION

The present invention improves speed of code execution through reduction of machine cycles needed to execute an instruction sequence of a type that has a segment of code with repeated execution, by providing multiple exit and/or multiple entry points in the sequence of instructions to define different segments of the sequence of instructions. Therefore, as a result, at least one segment has code that is only necessary in less than all of the repetitions.

Although, the embodiment example is described in the context of a computer system having the instruction set of a specific microprocessor, the embodiment may be used in other environments. The specific machine environment of the examples is microprocessors using two instruction sets. The invention (including the problem, cause, solution analysis) is useful with other processors, software operating systems and firmware with similar problems.

The embodiment example relates specifically to an instruction sequence of a type that has recursive execution, as distinguished from loop execution. A loop is not a recursive sequence, particularly at the procedural level. However, the broader invention is also applicable to non-recursive code.

A code modifier (for example a compiler), computer, computer system, method, computer readable medium, and a code signal, all as embodiments of the invention, are described.

The present embodiment is not limited to a specific instruction set, language or interface. It is applicable to an application binary interface (ABI) or to an application programming interface (API), as well as various programming languages, including procedure based computer languages and non-procedure based computer languages. An application Binary Interface (ABI) is a set of instructions that specifies how an executable file interacts with hardware and how information is stored; this is in contrast to an application programming interface (API), which is a set of routines used by an application program to direct the performance of procedures by the computer's operating system. A procedure based computer language is a programming language where the basic programming element is the procedure (a named sequence of statements, such as a routine, subroutine, or function; examples are FORTRAN, C, Pascal, Basic, Cobol and Ada).

Typically, in the prior art, function segments have a single entry point and one or more exit points. Multiple exit points are present if the program needs to exit earlier under specific conditions, conditional exits, or transfers. However, this restriction in a repeated sequence of instructions may cause certain instructions to be executed unnecessarily. For example, using an example instruction set, a PT instruction is used to initialize a target register with a specific branch target to transfer control to the target instruction. This PT instruction is typically executed early inside each function. When this function is recursive, then the PT instruction is executed unnecessarily on subsequent invocations after the initial invocation, which wastes processor machine cycles.

The embodiment defines multiple entry and/or multiple exit points to thereby define multiple code segments for a single function that is implemented by a recursive sequence of instructions. By scheduling instructions appropriately and by using multiple function entry and/or exit points, the number of instructions executed in the recursive sequence of instructions is minimized, thereby increasing performance, particularly speed and efficiency. In the above example of the present invention defining two entry points for a recursive sequence of instructions, and placing the PT instruction between the first and second function entry points, results in: 1) the first entry point being used by the external calling function to define an initially used code segment for the first invocation initiated by the external call; and 2) the second entry point being added and used by the internal (recursive) function calls to define an internally recursively called code segment of the recursive sequence of instructions. Therefore the thus placed PT instruction is executed only once independently of the number of invocations of the recursive sequence of instructions.

As a specific example of a recursive sequence of instructions analyzed as a part of the present invention, consider the following C code, wherein sumn( ) is a function that computes the sum of the first “n” numbers where “n” is provided as an argument to the function:

int sumn(int n) //n>=1.

```
{
  int i;
  for(i = n; i > 0; i −−)
  {
    return( (i==1) ? 1 : i + sumn(i−1) );
  }
}
main( )
{
  printf(“SUMN = % d\n”, sumn(10));
}
```

The inventor's analysis of the above sequence of instructions notes that the sumn( ) function internally calls itself recursively for a number of invocations depending upon the value of the input argument “n”, and therefore the sumn( ) function is a recursive sequence of instructions and of the type that has been found by the inventor to commonly have the above recognized and analyzed problems and causes. Continuing the problem, cause, solution inventive analysis, consider the following specific example processor assembly recursive sequence of instructions for the sumn( ) function, set forth in three columns of: instruction, parameters and comment:

| | | |
|---|---|---|
| _sumn: | | |
| LT_PT | .L14, TR0 | |
| ADDI.L | R15, #−16, R15 | // Adjust R15 => SP |
| ST.Q | R15, #8, R28 | // Save R28, a callee-save register |
| LT_PT | .L17, TR1 | |
| ST.Q | R15, #0, R18 | // Save R18 => return address |
| ADD | R63, R2, R28 | // Save “n” as “l” |
| BGE | R63, R28, TR0 | // Exit condition - for loop |
| .L13: | | |
| LT_PT | _sumn, TR2 | |
| BNEI | R28, #1, TR1 | // Check i==1 condition. |
| .L18: | | |
| MOVI | #1, R2 | // Return 1 when i equals 1. |
| LD.Q | R15, #0, R18 | |
| LD.Q | R15, #8, R28 | |
| ADDI.L | R15, #16, R15 | |
| PTABS | R18, TR0 | // Prepare return address |
| BLINK | TR0, R63 | // Return |
| .L17: | | |
| ADDI.L | R28, #−1, R2 | // Recursive call for n−1. |
| BLINK | TR2, R18 | |
| ADD.L | R2, R28, R2 | // i + sumn(i−1) |
| .L14: | | |
| LD.Q | R15, #0, R18 | |
| LD.Q | R15, #8, R28 | |
| ADDI.L | R15, #I6, R15 | |
| PTABS | R18, TR0 | |
| BLINK | TR0, R63 | |

_sumn% end:

In the inventive analysis of the above assembly sequence, the inventor notes that the three LT_PT instructions are unnecessarily executed during the invocations (the recursive calls) that occur after the first invocation, the number of which are determined by the value of the argument “n”. This unnecessary execution is caused by the three LT_PT instructions being needed only once within the recursive sequence of instructions of the sumn( ) function, specifically only during the first invocation of the recursive sequence of instructions. Accordingly, a solution is provided by: 1) grouping these three LT_PT instructions together in the beginning of the assembly recursive sequence of instructions after the externally called entry point, to define one segment of the recursive sequence of instructions; and 2) adding a recursive second entry point, for example, “sumn2( )” after the three LT_PT instructions, to define a second segment of the recursive sequence of instructions. When running the recursive sequence of instructions upon the function call, the three LT_PT instructions are executed in the first code segment followed by internal recursive execution of the second code segment. The recursive calls start at the second entry point to simply use the sumn2( ) function only and execute only the second defined code segment on the recursive calls, In this case, the _sumn label is used by external calls, whereas the _sumn2 label is used only within the sumn( ) function itself during the recursive invocations. The -sumn2 label is referred to herein as implementing an internal recursive call.

Therefore, the example assembly recursive sequence of instructions modified according to the solution of the present invention is as follows, set forth in columns of instruction, parameters and comment:

| | | |
|---|---|---|
| _sumn: | | |
| LT_PT | .L14, TR0 | |
| LT_PT | .L17, TR1 | |
| LT_PT | _sumn2, TR2 | |
| _sumn2: | | |
| ADDI.L | R15, #−16, R15 | // Adjust R15 => SP |
| ST.Q | R15, #8, R28 | // Save R28, a callee-save register |
| ST.Q | R15, #0, R18 | // Save R18 => return address |
| ADD | R63, R2, R28 | // Save “n” as “l” |
| BGE | R63, R28, TR0 | // Exit condition - for loop |
| .L13: | | |
| BNEI | R28, #1, TR1 | // Check i==1 condition. |
| .L18: | | |
| MOVI | #1, R2 | // Return 1 when i equals 1. |
| LD.Q | R15, #0, R18 | |
| LD.Q | R15, #8, R28 | |
| ADDI.L | R15, #16, R15 | |
| PTABS | R18, TR3 | // Prepare return address |
| BLINK | TR3, R63 | // Return |
| .17: | | |
| ADDI.L | R28, #−1, R2 | // Recursive call for n−l. |
| BLINK | TR2, R18 | |
| ADD.L | R2, R28, R2 | // i + sumn(i−1) |
| .L14: | | |
| LD.Q | R15, #0, R18 | |
| LD.Q | R15, #8, R28 | |
| ADDI.L | R15, #16, R15 | |
| PTABS | R18, TR4 | |
| BLINK | TR4, R63 | |

_sumn%end:

The solution of the embodiment for the example problem recursive sequence of instructions is in the creation of a separate entry point for the rescheduling of the sequence of instructions, to define multiple segments in the modified sequence of instructions, which saves three instructions for each recursive call or invocation beyond the first invocation. Therefore, instead of executing twenty-three instructions in each recursive call in the original sequence of instructions, now the sequence of instructions that is modified according to the embodiment has only 20 instructions executed in each recursive call. Therefore, the embodiment sequence of instructions has a 15% improvement in speed over the original sequence of instructions. Note that the original sequence of instructions is not the most optimized code version; the most optimized code version would have fewer total instructions and the percentage improvement in speed obtained by using the present embodiment would be even greater than 15%.

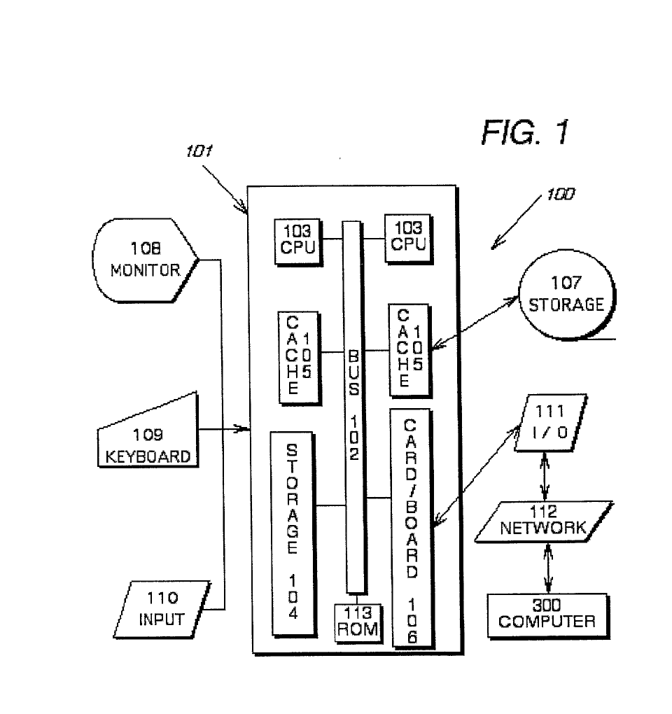

FIG. 1 illustrates a computer system 100, as an embodiment according to the present embodiment. Well-known structures and devices are shown in block diagram form in order to avoid unnecessarily obscuring the present embodiment. A computer 101 includes: a bus 102 for communicating information among one or more processors 103 (for example: micro-, mini-, super-, super scalar-, multi-, out-of-order-processors); main memory storage 104, such as a random access memory (RAM) or other dynamic storage device, coupled to the bus 102 for storing information and instructions to be executed and used by the processors 103; and a cache memory 105, which may be on a single chip with one or more of the processors (e.g. CPUs) 103 and coupled with the bus 102. The storage 104 and one or more cache memories 105 are used for storing temporary variables in registers Rn and temporary registers TRn, or for storing other intermediate information during execution of instructions by the processors 103. The storage 104 and/or the peripheral storage 107 and/or the firmware ROM 113 are examples of computer readable media physically implementing the method and used for storing the program or code embodiment. Also, the method of the embodiment may be implemented by hardware on a card or board. The hardware, software and media used to implement the embodiment may be distributed on the network 112 to another computer 300.

The peripheral storage 107 may be a magnetic disk or optical disk, having computer readable media. The computer readable media may contain code/data, which, when run on a general purpose computer, constitutes the embodiment code modifier and thereby provides an embodiment special purpose computer. A display 108 (such as a cathode ray tube (CRT) or liquid crystal display (LCD) or plasma display), an input device 109 (such as a keyboard, mouse, VUI, and any other input) 110 are coupled to the computer 101. An input/output port (I/O) 111 couples the computer with other structure, for example with the network 112 (a LAN, WAN, WWW, or the like), to which is coupled another similar computer system 300, so that the computer system 100 may execute with the code modifier of the computer system 300, or vice versa.

Code modification is provided by the computer system 100 prior to storage, transfer, execution or reproduction of the modified code, for example during compiling. Code modification may be provided by the computer system 100 immediately prior to or during the processor 103 or 300 execution of a sequence of instructions that is being output from the code modifier, which may be specifically implemented by a compiler. Code modification and execution of modified code would be effectively conducted on a real time basis or substantially simultaneously, both by the operating system itself. The code modification and execution may be in different computer systems or conducted with different processors in the same computer system. An original sequence of instructions and/or the code to control the code modification can be read into main memory 104 from another computer system 300 or from a computer readable medium, such as the storage 107 and thereby constitute a signal embodiment of the present invention.

In alternative embodiments, hard-wired circuitry 106 may be used in place of or in combination with software 107 or firmware 113 instructions to implement the method, signal, apparatus and system embodiments of the present invention. Thus, embodiments of the present invention are not limited to any specific combination of hardware, firmware and software.

The I/O 111 provides two-way data communication coupling to the network 112. The I/O may be a digital subscriber line (DSL) card or modem, an integrated services digital network (ISDN) card, a cable modem, a telephone modem, a cable, a wire, or a wireless link to send and receive electrical, electromagnetic or optical signals that carry digital data streams representing various types of information, including instruction sequences. The communication may include a Universal Serial Bus (USB), a PCMCIA (Personal Computer Memory Card International Association) interface, etc. One of such signals may be a signal implementing the present invention.

Various forms of computer-readable media may be involved in providing code modification instructions to a processor for execution, including code to transform a general purpose computer into a special purpose computer that will thereby include the code modifier of the present embodiment. For example, the instructions for carrying out at least part of the present invention (with the multiple access points, which are exit points and or entry points, for eliminating unnecessary instruction executions by defining multiple code segments within the sequence of instructions) may initially be on a magnetic disk computer-readable media of the remote computer 300, optical disc, flash memory, or alternatively, on the like computer-readable media of storage 107 locally associated with the processors 103 to execute the code modification instructions or be transmitted to a remote computer 300. In the later scenario, the remote computer may load the received code modification instructions onto a computer-readable media. Or, the remote computer may load the instructions into main memory and send the instructions over a telephone line using a modem, wherein the instructions are stored on the computer-readable media of the modem. A modem (having a computer-readable media) of a local computer system may receive the data on a transmission line and send the code data to a computer-readable media coupled to a portable computing device, such as a personal digital assistance (PDA) and a laptop. The instructions received by main memory may optionally be stored on a storage device either before or after execution by a processor. In any event, the invention includes code modification instructions on a computer readable medium and as a data stream signal.

The term “computer-readable medium” as used herein refers to any medium that participates in providing instructions to the processor 103 or 113 for execution. Such a medium may take many forms, including but not limited to non-volatile media, volatile media, and transmission media. Non-volatile media include, for example, optical or magnetic disks, such as storage device 107. Volatile media include dynamic memory, such as main memory 104. Transmission lines providing the described couplings may include coaxial cables, copper wire, wireless links and fiber optics. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read code.

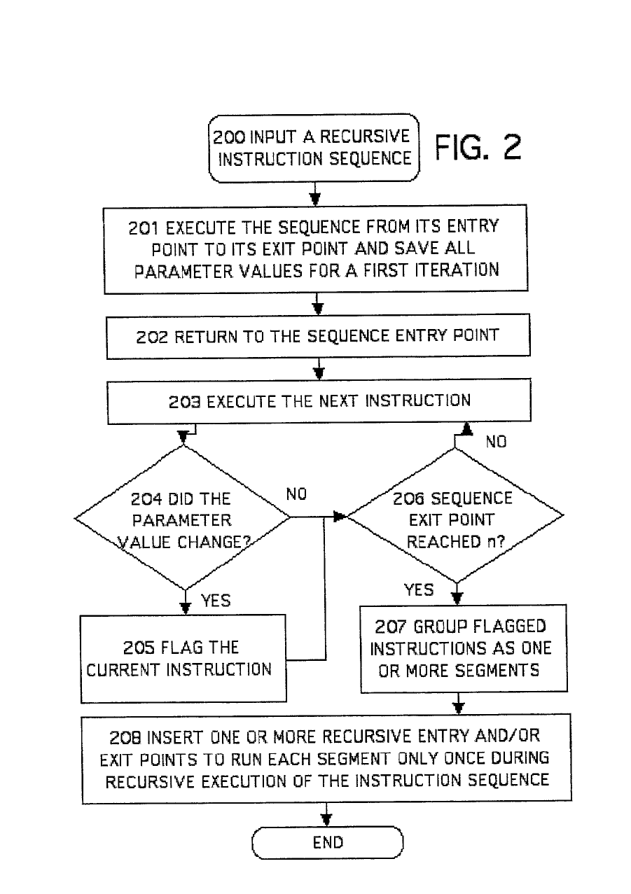

FIG. 2 is a flowchart showing the method of operating the system and guidelines to write a program to implement a recursive instruction sequence modifier, as an embodiment.

In step 200, a recursive sequence of instructions is provided as an input to the method of operation and to the code modifier. The recursive sequence of instructions is preferably in a procedure based language when the method is performed by hand. A compiled recursive sequence of instructions is most preferred for efficient machine performance, which may be on real time with execution of the modified recursive sequence of instructions immediately after modification, for example as when an emulator produces a recursive sequence of instructions having the above mentioned problems and the recursive sequence of instructions is modified immediately prior to execution by a compiler or scheduler, or as a part of the execution by the operating system. Alternatively. the modified recursive sequence of instructions may be stored on computer readable medium for subsequent use.

In step 201, the recursive recursive sequence of instructions is executed or analyzed as if executed for at least one or initial invocation, preferably from its externally called start point to its external exit point. The analysis is sufficient to determine the parameter values associated with the executed instructions, which values are stored in association with the instruction that produced them and in association with their code named storage location (for example, TR0 designates a specific temporary register TR for storing a value or for storing an external address where the value resides in a different location, step 201 generates, for example, a look up table storing each value associated with the code location or instruction that produced and the code named location for temporarily storing the value).

Step 202 returns execution to the start point of the recursive sequence of instructions, which is a recursive call for a recursive to invocation.

Step 203 executes the next instruction of the recursive sequence of instructions, which at this time is the first instruction following the externally called start point of the recursive sequence of instructions. This execution generates and stores values for various parameters, as indicated by the recursive sequence of instructions. Step 203 may continue to execute successive instructions until a parameter value is generated. After step 203, processing passes to step 204.

In step 204, the parameter values generated in step 203 are compared to the corresponding values stored in the look up table produced in step 201. If they are the same, the process proceeds to step 206, and if they are not the same, then the process proceeds to step 205.

In step 205, the instruction that generated a changed parameter value, that is the instruction executed in step 203 to generate the parameter value that was found by step 205 to differ from the look-up table value as generated in step 201, is flagged as a parameter value generating instruction that needs to be executed in each recursive invocation. The process then proceeds to step 206.

In step 206, the sequence is checked to see if there have been n invocations to reach the external exit point. When the exit point has been reached after n invocations or when there have been a number of invocations less than n that is sufficient to identify the cause of unnecessary machine cycles, the process proceeds to step 207, otherwise the process returns to step 203.

In step 207, instructions of the recursive sequence of instructions that affect a parameter value and that have not been flagged in step 205 are grouped into one or more recursive segments. Some unflaged instructions must necessarily remain with some flagged instructions where there is a dependent relationship such that they are needed for recursive invocations, and this dependency is easily determined with a look up table showing such dependency. The remainder of the code being grouped into one or more non-recursive or unflaged segments.

Step 208 separates each of the recursive segments or a group of plural recursive segments from the remainder of the recursive sequence of instructions by one or more added internal entry points and/or internal exit points, known herein as internal recursive access points, so that non-recursive segments of the recursive sequence of instructions will be executed on only one invocation or less than all invocations of the recursive sequence of instructions (the first invocation and not the recursive invocations in the embodiment) during normal execution. In the above embodiment example, the non-recursive segment was at or moved to become the beginning of the recursive sequence of instructions and separated by a recursively called entry point from the remaining segments of the recursive sequence of instructions. Therefore, when execution makes a recursive call, return is to the internal added recursive entry point and not to the original externally called entry point.

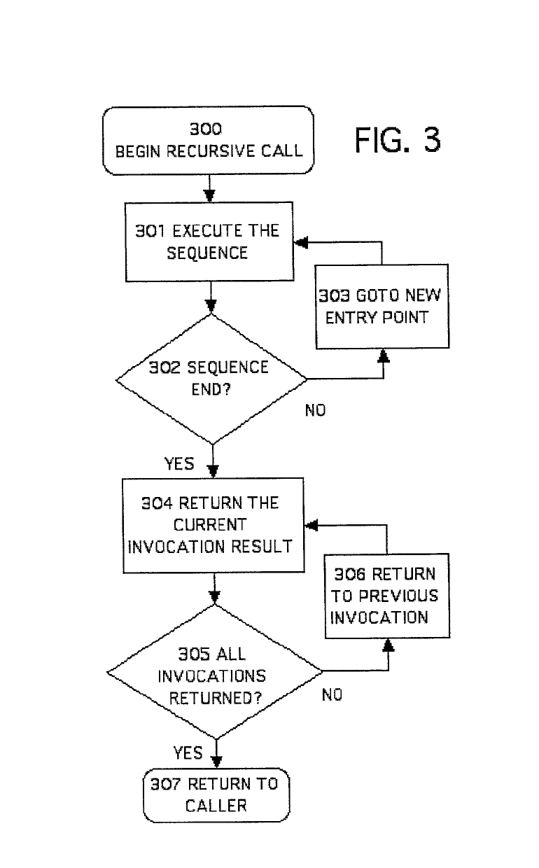

In the FIG. 3 flowchart, a recursive sequence of instructions is called from some program or operating system, not shown in FIG. 3, but which may be from a computer of FIG. 1, resident or distributed.

Step 300 is the entry point of the recursive sequence.

Step 301 executes the sequence of instructions, and collects dynamic execution information.

Step 302 determines the end of the execution of the sequence of instructions.

Step 303 controls the start point of each recursive execution by providing a new entry point for the invocations that are after the initial invocation that startecd at step 300. The new entry point is determined and the sequence modified as explained above to provide an initial sequence from the original external entry point of step 300 to the internal new entry point, bounding some of the code of the sequence of instructions, and another segment from the new entry point to the original external exit point. Both segments are executed initially and the recursive invocations execute only the latter segment. Step 303 is new to the present invention and the remaining steps may be in accordance with well known technology of the prior art.

Step 304, reached when step 302 determines the end of the sequence, returns the current invocation result.

Step 305 determines if all of the invocation results have been returned to the calling program, and if not step 306 returns to the previous invocation and passes control to step 304. When all of the invocation results are returned, step 307 returns operation to the calling program or operating system by the original external exit point of the sequence of instructions.

The addition of the new entry point in step 303 may be part of a permanent modification of the sequence of instructions or only a temporary modification. The temporary modification may be only for the method of FIG. 3 and not passed to the calling program or operating system, and effectively the presence of step 303 is transparent to the environment beyond FIG. 3, except as to improved execution results. Alternatively, the modification of step 303 may be permanent so that the sequence of instructions as modified is returned or stored.

FIG. 3 may be easily modified to exemplifiy the invention as applied to the provision of a new exit point. As an alternative example, the non-recursive segment of the recursive sequence of instructions, moved or not, may be bounded by an added internal recursive exit point and an added internally called recursive entry point, to effectively bypass the non-recursive segment upon the recursive invocations of the recursive sequence of instructions.

As a further alternative example, the non-recursive segment of the recursive sequence of instructions may be moved to become the end segment of the recursive sequence of instructions and separated from the remaining code of the recursive sequence of instructions by an added internal recursive exit point. Thereby the added internal recursive exit point will recursively call the original entry point only for recursive invocations other than the initial invocation or other than less than all of the invocations of the recursive sequence of instructions, until n invocations have occurred.

That is, in the examples, the independent segment of the sequence of instructions is isolated by adding internal access points so that the independent segment of the sequence of instructions is run for less than all of the repetitions of the sequence of instructions, when executed, no matter how great is the value of n.

The above examples are exemplary of a more general case involving adding multiple entry and/or exit points for creating plural code segments of a sequence of instructions, resulting in at least one code segment being repeated less than n times in a single repetative sequence of instructions that as a whole has a number of repetitions n.

The embodiments are particularly useful in efficiently scheduling code for procedure based languages, thereby improving execution performance by eliminating unnecessary machine cycles. This invention may be implemented while scheduling a function; alternatively, this invention can be implemented in a compiler or by software, or by hardware, or a combination of the above.

While the present invention has been described in connection with a number of embodiments, implementations, modifications and variations that have advantages specific to them, the present invention is not necessarily so limited according to its broader aspects, but covers various obvious modifications and equivalent arrangements according to the broader aspects, all according to the spirit and scope of the following claims.

1. A method for improving execution performance of a repeated sequence of instructions that provide a function and having external access points that are external entry and external exit points, comprising the steps of:
determining at least one instruction, from the sequence of instructions, that is necessary to be executed for less than all repetitions of the sequence of instructions; and
modifying the sequence of instructions to isolate the one instruction from only some of the repetitions of the sequence of instructions.

2. The method of claim 1, wherein:
said modifying includes the step of inserting at least one internal access point within the sequence of instructions and thereby partitioning the sequence of instructions into multiple segments, and having one of the multiple segments including the one instruction and executing for fewer times than the number of executions of another of the multiple segments.

3. The method of claim 2, wherein
said inserting step inserts the one internal access point as an internal recursive entry point.

4. The method of claim 3, wherein
said modifying includes the step of moving the one instruction from outside of the one of the multiple segments to within the one of the multiple segments and between one of the external access points and the internal recursive access point.

5. The method of claim 2, wherein
said modifying includes the step of moving the one instruction from outside of the one of the multiple segments to within the one of the multiple segments and between one of the external access points and the internal access point.

6. The method of claim 1, wherein
said modifying includes the step of rescheduling the one instruction closer in sequence of execution to one of the external access points.

7. A computer readable storage media having computer readable code physically implementing a method of improving execution performance of a sequence of instructions, the code including statements for performing the method of claim 1.

8. A computer readable storage media having computer readable code physically implementing a method of improving execution performance of a sequence of instructions, the code including statements for performing the method of claim 2.

9. A computer readable storage media having computer readable code physically implementing a method of improving execution performance of a recursive sequence of instructions, the code including statements for performing the method of claim 5.

10. A computer readable storage media having computer readable code physically implementing a method of improving execution performance of a sequence of instructions, the code including statements for performing the method of claim 6.

11. A computer system including the computer readable storage media of claim 7, further comprising:
at least one processing unit coupled to said computer readable storage media for executing the sequence of instructions of the computer readable code; and
said computer readable storage media including at least one of volatile and non-volatile memory.

12. A computer system including the computer readable storage media of claim 8, further comprising:
at least one processing unit coupled to said computer readable storage media for executing the sequence of instructions of the computer readable code; and
said computer readable storage media including at least one of volatile and non-volatile memory.

13. A computer system including the computer readable storage media of claim 9, further comprising:
at least one processing unit coupled to said computer readable storage media for executing the sequence of instructions of the computer readable code; and
said computer readable storage media including at least one of volatile and non-volatile memory.

14. A computer system including the computer readable storage media of claim 10, further comprising:
at least one processing unit coupled to said computer readable storage media for executing the sequence of instructions and the computer readable code; and
said computer readable storage media including at least one of volatile and non-volatile memory.

15. A method of machine executing a called program of a repeated sequence of instructions having at least one instruction that is necessary to be executed for less than all repetitions of the program, comprising:
executing at least some of the sequence of instructions from an externally called entry point in the program initially;
thereafter repeatedly calling the program;
in response to said repeatedly calling, executing only some of the sequence of instructions;
thereafter exiting the program from an exit point; and
controlling at least one of said steps of executing with an internal access point other than the entry point and the exit point to isolate the one instruction within the sequence of instructions from at least one of said repeatedly calling and to execute the one instruction a number of times fewer than the total number of executions of the entire sequence of instructions.

16. A method of machine executing according to claim 15, wherein:
said first-mentioned executing, includes executing the one instruction;
said internal access point is an internal recursive entry point scheduled after the one instruction in the sequence of instructions; and
said second-mentioned executing recursively starts from the internal recursive entry point.

17. A method of processing, comprising:
providing a sequence of instructions repeatable to perform a function and having at least one instruction that is necessary to be executed for less than all repetitions of the sequence of instructions; and
providing an internal access point other than an externally called entry point and an external exit point, which internal access point isolates the one instruction within the sequence of instructions from only some of the repetitions so that the one instruction is within less than all of the repetitions.

18. The method of claim 17, wherein all of said steps are included within a step of storing a program.

19. The method of claim 17, wherein all of said steps are included within a step of transmitting a program.

20. The method of claim 17, wherein all of said steps are included within a step of receiving a program.

21. The method of claim 17, wherein all of said steps are included within a step of executing a program.

22. The method of claim 17, wherein all of said steps are included within a step of machine modifying a program.

23. A code rescheduler, comprising:
a storage media; and
means for rescheduling at least one instruction of a repeated sequence of instructions for execution by at least one and by less than all repetitions of the sequence of instructions.

24. A code rescheduler according to claim 23, wherein:
said means for rescheduling providing internal recursive access between an entry point and an exit point of the sequence of instructions.
